(19) United States
(12) Patent Application Publication
(10) Pub. No.: US 2006/0114240 A1
(43) Pub. Date: Jun. 1, 2006

(54) Controlling device for cursor and method for operating the same

(75) Inventor: Yi-Chan Lin, Taipei City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Holtek Semiconductor Inc., Hsinchu (TW)

(21) Appl. No.: 11/122,528

(22) Filed: May 5, 2005

(30) Foreign Application Priority Data
Nov. 5, 2004 (TW) 093133915

(51) Int. Cl. G09G 5/00

(52) U.S. Cl. 345/173

(57) ABSTRACT

A controlling device for the cursor and the method for operating the same are provided. The controlling device includes a capacitor array having a plurality of equivalent capacitors, a microprocessor electrically connected to the capacitor array for sending a pulse train to the capacitor array in the x-direction and receiving a potential of each equivalent capacitor in the y-direction so as to determine a movement of a cursor, and a charge-absorbing device disposed above the capacitor array, wherein when the charge-absorbing device is moved correspondingly to a position of a specific equivalent capacitor in the capacitor array, a storage charge of the specific equivalent capacitor is absorbed so that the potential thereof is lowered, and thereby the movement of the cursor is determined by the microprocessor.

### FIELD OF THE INVENTION

The present invention relates to a controlling device and the operating method therefor, and more particularly to a controlling device for controlling the movement of a cursor and the operating method therefor.

### BACKGROUND OF THE INVENTION

Presently, there are two types of mice available for the computer in the market. One is the semi-optical mouse, and the other is the optical one. The semi-optical mouse generally includes two shafts perpendicular to each other, a photo-interceptor and a trackball, wherein an X-axial and a Y-axial photoreceptors are configured on the two shafts respectively. The photo-interceptor includes a light-emitting diode and a photo-transistor. When the semi-optical mouse is moved, the X-axial and the Y-axial photoreceptors will be driven by the trackball. Meanwhile, the light emitted from the light-emitting diode to the photo-transistor would propagate through the apertures of the X-axial and the Y-axial photoreceptors. This enables the photo-transistor to generate a series of data pulses for detecting the movement of the cursor. Therefore, the movement of the cursor can be identified by the two shafts with the X-axial and the Y-axial photoreceptors and the photo-interceptor. However, the semi-optical mouse has the following disadvantages.

Firstly, the sensitivity and accuracy for the movement detection of the cursor will be reversely influenced if the trackball is dirty or if the shafts are covered with dust. Hence, it is necessary to clean the trackball and the shafts regularly.

Secondly, the resolution for the semi-optical mouse will be affected by the contact between the trackball and the shafts. The combination between the trackball and the shafts will deteriorate as the user moves the mouse rapidly, which may results in an instability for the cursor movement. Thus, in current fabrication of the semi-optical mouse, the weight of the trackball should be heavier in order to avoid the deteriorated combination between the trackball and the shafts.

Thirdly, the semi-optical mouse not only needs a lot of components for assembly but the structure thereof is complicated. Hence, it is difficult to reduce the fabrication cost therefor.

As for the optical mouse, the movement of the cursor is identified by detecting the light reflecting between the sliding plane. Still, the optical mouse has the following disadvantages.

Firstly, it will consume a lot of current during the mouse movement. Therefore, the life of the battery will be shorter if the mouse is operated in a wireless way.

Secondly, it needs a photo IC as well as a microprocessor to be operated for the data transmission. Hence, the space design for the mouse is limited.

Thirdly, the better the resolution of the mouse is, the higher the price of the photo IC will be.

Please refer to FIG. 1, which schematically shows a conventional notebook computer with a touch pad for functioning as a mouse. The conventional notebook computer with a touch pad that functions as a mouse to control the movement of the cursor is shown in FIG. 1. The capacitance-induced way is applied in the touch pad 111 for the conventional notebook computer 11. The charge of the capacitor varies with the movement of a user's fingers on the circuit board, so that the cursor can be moved or the mouse-click can be performed. Although the price of the touch pad 111 for the conventional notebook computer 11 is getting down, it is easy to injure the user's wrist when the user operates the touch pad 111 over a long period of time.

Please refer to FIG. 2, which shows the capacitance response cursor for an IBM notebook computer. As shown in FIG. 2, besides the touch pad 211, the IBM notebook computer further includes a capacitance response cursor 212 protruding from the keyboard for controlling the movement of the cursor. The speed for the movement of the cursor is determined according to the force applied on the capacitance response cursor 212 by the user. The structure of the capacitance response cursor 212 is simple and does not occupy much space. Moreover, the linear control for the cursor is superior.

Nevertheless, using the capacitance response cursor 212 to control the movement of the cursor has the following disadvantages. Firstly, because the user has to apply force constantly on the capacitance response cursor 212 to make the cursor move rapidly, his finger and wrist joints will be injured when the user operates it over a long period of time. Secondly, for the application of the precise drafting, the position of the cursor is unable to be controlled accurately.

In order to overcome the drawbacks in the prior art, a novel controlling device for the cursor and a method for operating the same are provided. The particular design in the present invention not only solves the problems described above, but also is easy to be implemented. Thus, the present invention has the utility for the industry.

### SUMMARY OF THE INVENTION

In accordance with one aspect of the present invention, a controlling device is provided. The provided controlling device is advantageous for its low cost, simple design, low operating current and adjustable resolution. Furthermore, it is not necessary to clean the mouse having the provided controlling device therein.

In accordance with another aspect of the present invention, a controlling device is provided. The controlling device includes a capacitor array having a plurality of equivalent capacitors, a microprocessor electrically connected to the capacitor array for sending a pulse train to the capacitor array in x-direction and receiving a potential of each equivalent capacitor in y-direction so as to determine a movement of a cursor, and a charge-absorbing device disposed above the capacitor array. Preferably, when the charge-absorbing device is moved correspondingly to a position of a specific equivalent capacitor in the capacitor array, a storage charge of the specific equivalent capacitor is absorbed so that the potential thereof is lowered, thereby the movement of the cursor being determined by the microprocessor.

Preferably, the capacitor array is in the shape of one selected from a group consisting of a cross, a snake, a comb, a circle and a spiral.

Preferably, the charge-absorbing device is one of a rod and a cone bodies.

Preferably, when the charge-absorbing device is connected to the specific equivalent capacitor, the potential thereof is even lowered, and thereby a function is performed as a mouse-click.

Preferably, when the charge-absorbing device is successively connected to the specific equivalent capacitor and then moved away, a function as a scroll wheel is performed.

Preferably, the charge-absorbing device is operated by a user's fingers.

Preferably, the charge-absorbing device is made of an electrically conductive material so that the storage charge of the specific equivalent capacitor is absorbed by the user's fingers via the charge-absorbing device.

Preferably, the charge-absorbing device has a grounded metal bar disposed at a front end thereof for absorbing the storage charge of the specific equivalent capacitor.

Preferably, the controlling device further includes a housing and an operating portion.

Preferably, the operating portion is an elastic rubber piece.

Preferably, the elastic rubber piece is disposed on the housing and connected to the charge-absorbing device for the user to easily operate therethrough with his fingers so as to control the movement of the cursor.

Preferably, the capacitor array and the microprocessor are disposed on a common printed circuit board.

In accordance with a further aspect of the present invention, a method for operating the mentioned controlling device is provided. The method includes steps of determining a movement of a cursor by the microprocessor when the charge-absorbing device is moved correspondingly to a position of a specific equivalent capacitor in the capacitor array and thus a storage charge of the specific equivalent capacitor is absorbed and the potential thereof is lowered, and determining a selection as a mouse-click by the microprocessor when the charge-absorbing device is connected to the specific equivalent capacitor and thus the potential thereof is even lowered.

Preferably, the pulse train is sent to the capacitor array in x-direction.

Preferably, the potential of each equivalent capacitor is received from the capacitor array in y-direction.

Preferably, the method further includes a step of performing a function as a scroll wheel when the charge-absorbing device is successively connected to the specific equivalent capacitor and then moved away.

In accordance with further another aspect of the present invention, a method for operating the mentioned controlling device is provided. The method includes steps of determining a movement of a cursor by the microprocessor when the charge-absorbing device is moved correspondingly to a position of a specific equivalent capacitor in the capacitor array and thus a storage charge of the specific equivalent capacitor is absorbed and the potential thereof is lowered, and performing a function as a scroll wheel when the charge-absorbing device is successively connected to the specific equivalent capacitor and then moved away.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 shows the touch pad for a conventional notebook computer;

FIG. 2 shows the capacitance response cursor for an IBM notebook computer;

FIG. 3 is a schematic diagram showing the interior arrangement of the controlling device according to a preferred embodiment of the present invention;

FIG. 4 is a flow chart showing the steps executed by the microprocessor according to a preferred embodiment of the present invention;

FIG. 5 shows the capacitor array according to a preferred embodiment of the present invention;

FIGS. 6(a)˜6(d) show the capacitor arrays according to further preferred embodiments of the present invention;

FIG. 7 shows the flow of the storage charges in the equivalent capacitors when using the charge-absorbing device made of an electrically conductive material;

FIG. 8 shows the flow of the storage charges in the equivalent capacitors when using the charge-absorbing device having a grounded metal bar disposed at its front end;

FIG. 9(a) is a side view showing the controlling device according to a preferred embodiment of the present invention;

FIG. 9(b) is a top view showing the controlling device according to a preferred embodiment of the present invention;

FIG. 9(c) is a cross-sectional view showing the controlling device according to a preferred embodiment of the present invention; and

FIG. 10 shows the operating method for the controlling device according to a preferred embodiment of the present invention.

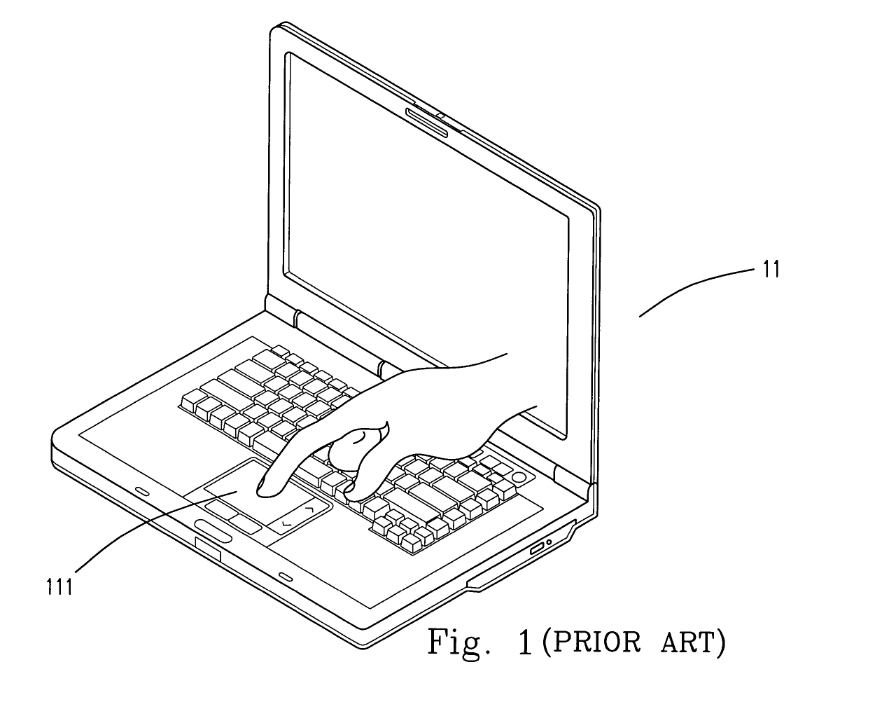

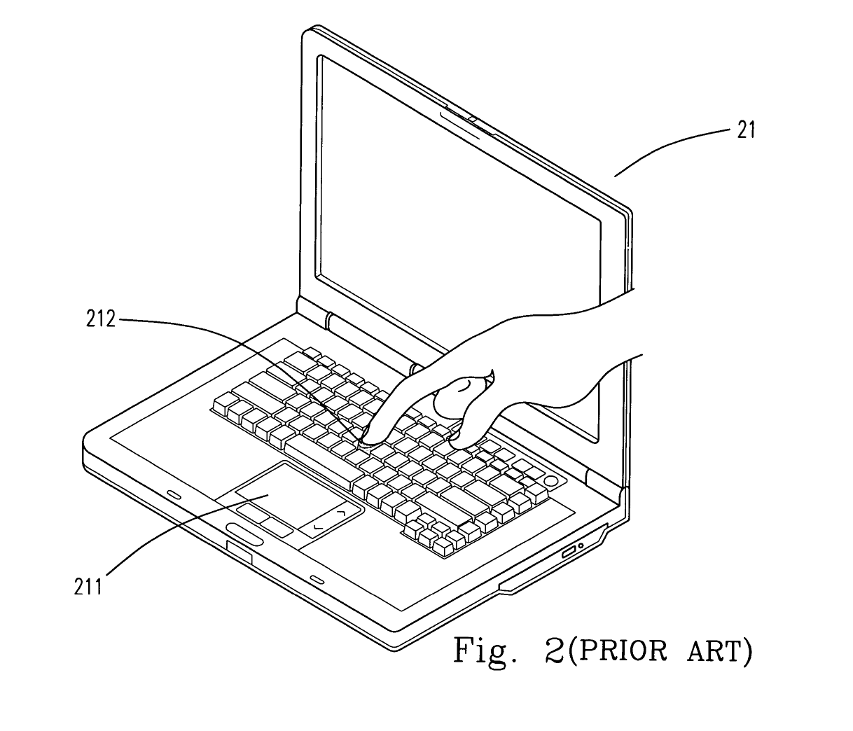

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

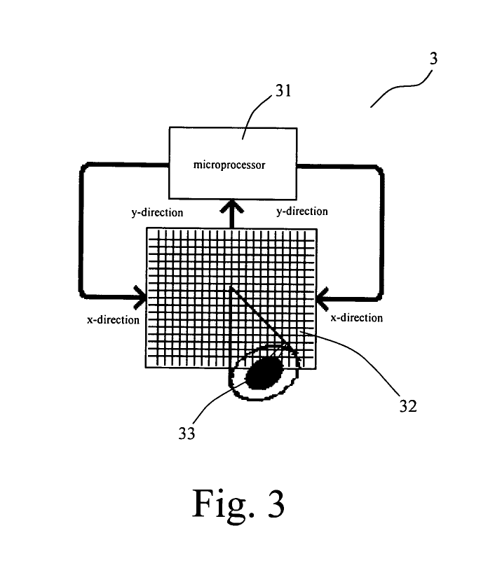

Please refer to FIG. 3, which shows the interior arrangement of the controlling device according to a preferred embodiment of the present invention. Generally, the controlling device functions as a mouse to control the movement of the cursor. The controlling device 3 mainly includes a microprocessor 31, a capacitor array 32 having a plurality of equivalent capacitors, and a charge-absorbing device 33 which is a rod or a cone bodies. In the controlling device 3, a pulse train is sent by the microprocessor 31 to the capacitor array 32 in the x-direction, and the potential of each equivalent capacitor is received by the microprocessor 31 from the capacitor array 32 in the y-direction so that the potential thereof is determined. In order to further determine the movement of the cursor, the charge-absorbing device 33 is disposed above the capacitor array 32. The position of the cursor can be changed by controlling the charge-absorbing device 33 through the user's fingers. When the charging potential of each equivalent capacitor in the capacitor array 32 is received by the microprocessor 31, where the charge-absorbing device 33 lies in the capacitor array 32 is determined.

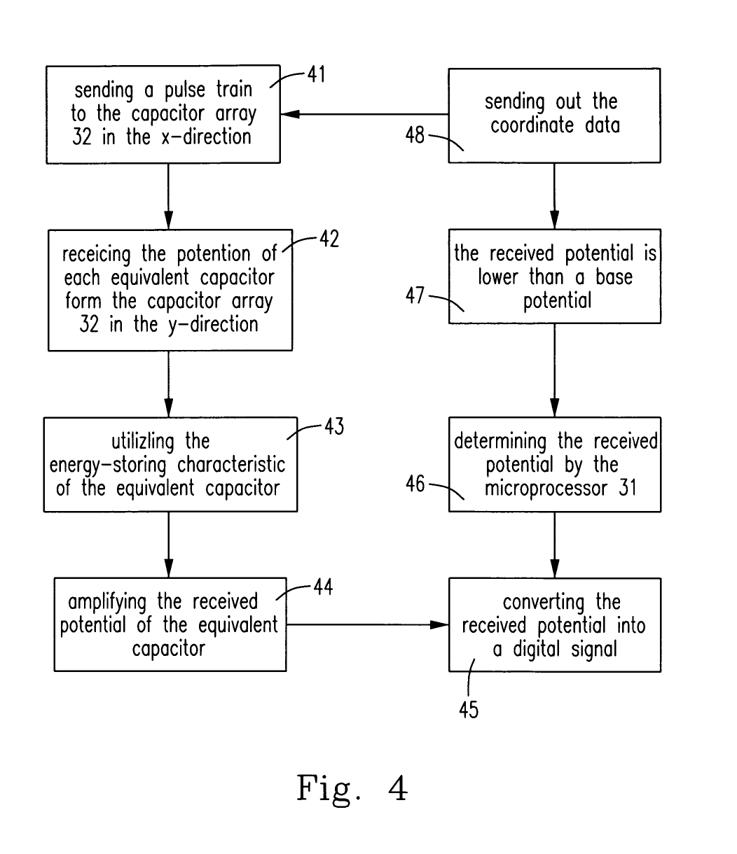

Please refer to FIG. 4, which is a flow chart showing the steps executed by the microprocessor 31 according to a preferred embodiment of the present invention. The steps executed by the microprocessor 31 are as follows:

(a) A pulse train is sent by the microprocessor 31 to the capacitor array 32 in the x-direction (step 41);

(b) The potential of each equivalent capacitor is received by the microprocessor 31 from the capacitor array 32 in the y-direction (step 42);

(c) The energy-storing characteristic of the equivalent capacitor is utilized (step 43);

(d) The received potential of the equivalent capacitor is amplified (step 44);

(e) The received potential is converted into a digital signal (step 45);

(f) The received potential is determined by the microprocessor 31 (step 46); and

(g) The coordinate data are sent out (step 48) when the received potential is lower than a base potential (step 47) so that the movement of the cursor is determined.

The production cost of the controlling device according to the present invention is very low since it is unnecessary to use extra photo components. It only needs to dispose the capacitor array 32 on the printed circuit board (PCB) of the controlling device, and then employs the microprocessor 31 to perform the control and detection. The charge-absorbing device 33 is disposed above the capacitor array 32. An even lower potential is sensed by the microprocessor 31 if the charge-absorbing device 33 is connected to the capacitor array 32, and thus the function as a mouse-click is performed. The function as a scroll wheel is performed if the charge-absorbing device 33 is successively connected to the capacitor array 32 and then moved away. Besides, the operating current for the controlling device of the present invention is very low since the cursor detection thereof does not utilize the way of light detection. This enables a longer battery life for the controlling device when it is used in a wireless way. Moreover, the resolution can be adjusted by the user through controlling the microprocessor 31.

In the present invention, a pulse train is sent by the microprocessor 31 to the capacitor array 32 in the x-direction for charging. Then, the potential of each equivalent capacitor is received by the microprocessor 31 from the capacitor array 32 in the y-direction so as to determine the charging state of each equivalent capacitor. The electric field of the capacitor array 32 will be affected when the charge-absorbing device 33 for cursor control is moved thereon. This causes the equivalent capacitor to be insufficiently charged and the potential thereof to be lowered. Therefore, the movement of the cursor can be determined by the microprocessor 31, and thus the purpose of cursor detection is achieved.

The present invention not only significantly reduces the production cost for the controlling device but the structure thereof is simple. The main body of the controlling device can be accomplished merely by the combination of a housing and an operating portion. The housing includes an upper housing and a lower housing, and the operating portion is preferably an elastic rubber piece. Due to the simple structure, the controlling device of the present invention can be designed for a lightweight and compact form. Besides, it is not necessary for the user to apply too much force on the controlling device, and hence the cursor can be moved easily. Therefore, the present invention not only fits the ergonomics but reduces the production cost. If the controlling device of the present invention is applied in the notebook computer, it will be easier and more convenient to operate than the capacitance response cursor 212 and the touch pad 211 for the IBM notebook computer 21.

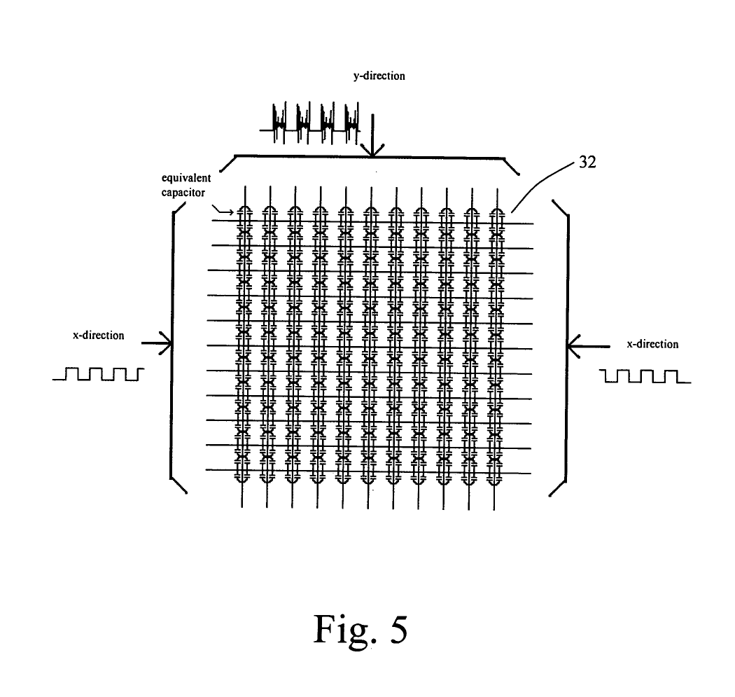

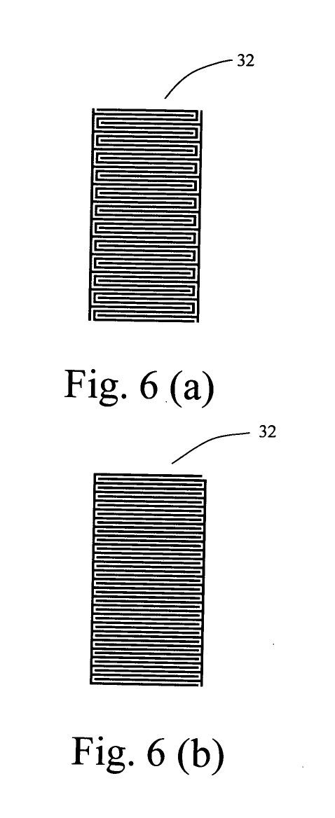

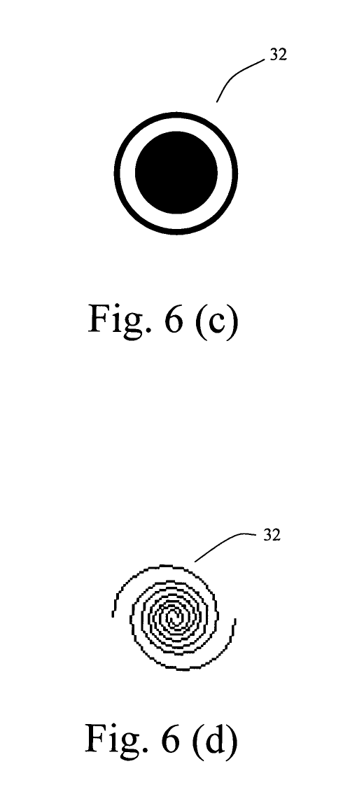

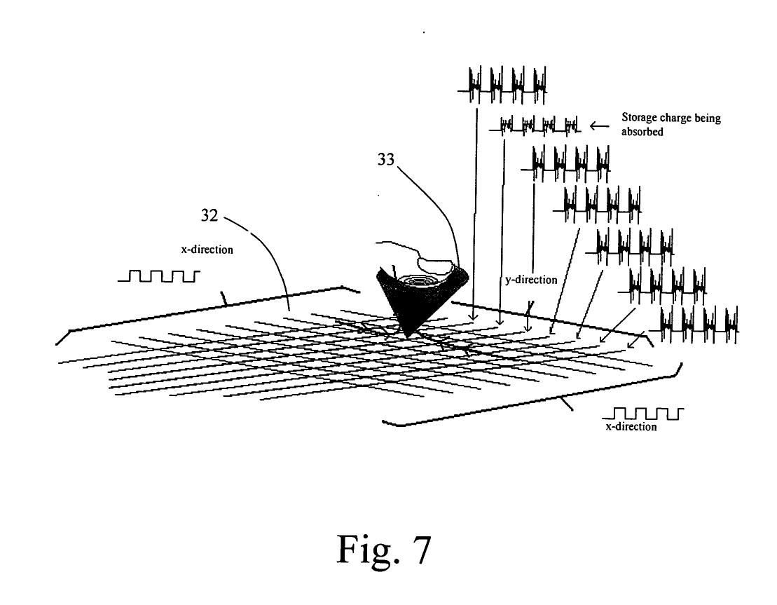

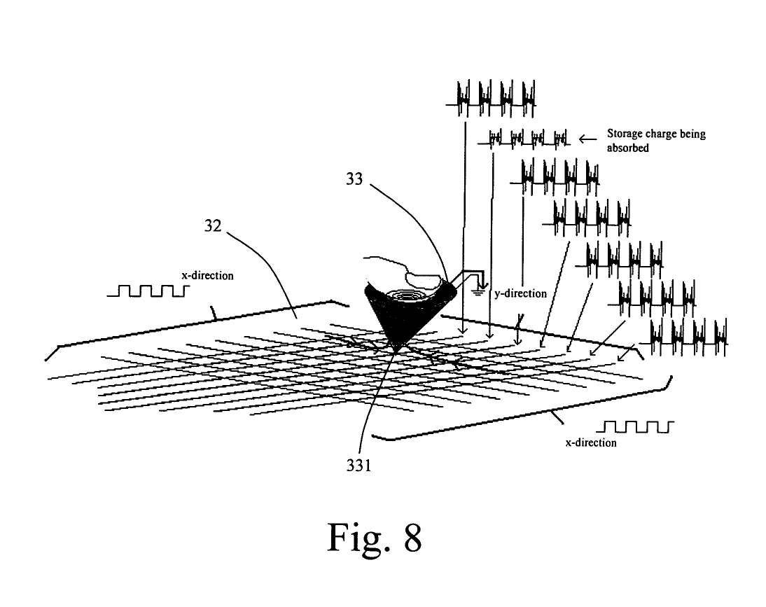

The controlling device of the present invention generally includes the microprocessor 31, the capacitor array 32 and the charge-absorbing device 33. The microprocessor 31 is mainly used for determining the coordinates and the potential levels of the equivalent capacitors in the capacitor array 32 so as to identify the positions of the cursor and perform the functions as a mouse-click or as a scroll wheel. For the design of the capacitor array 32, a cross-shaped pattern as shown in FIG. 5 is disposed on the printed circuit board as shown in FIG. 5. Such a cross-shaped pattern results in the smallest area of the unit equivalent capacitor. However, other kinds of patterns still can be applied according to actual needs, such as a snake-shaped one shown in FIG. 6(a), a comb-shaped one shown in FIG. 6(b), a circle-shaped one shown in FIG. 6(c) and a spiral-shaped one shown in FIG. 6(d). The above patterns are used for forming a plurality of equivalent capacitors in the sense area of the printed circuit board. Because the charge-absorbing device 33 is a control element, there are two ways for its implementation. One way is to fabricate the charge-absorbing device 33 with the electrically conductive material, so that the storage charge of the equivalent capacitor can be absorbed by the contact between the human body and the charge-absorbing device 33, as shown in FIG. 7. That is, when the charge-absorbing device 33 is moved correspondingly to the position of a specific equivalent capacitor in the capacitor array 32, the storage charge of the specific equivalent capacitor will be absorbed by the user's fingers via the charge-absorbing device 33. Thus, the potential of the specific equivalent capacitor is lowered, and thereby the movement of the cursor is determined by the microprocessor 31. The other way is to dispose a grounded metal bar 331 at the front end of the charge-absorbing device 33 for absorbing the storage charge of the equivalent capacitor, as shown in FIG. 8. Namely, when the charge-absorbing device 33 is moved correspondingly to the position of a specific equivalent capacitor in the capacitor array 32, the storage charge of the specific equivalent capacitor will be absorbed by the grounded metal bar 331. Hence, the potential of the specific equivalent capacitor is lowered, and thereby the movement of the cursor is determined by the microprocessor 31.

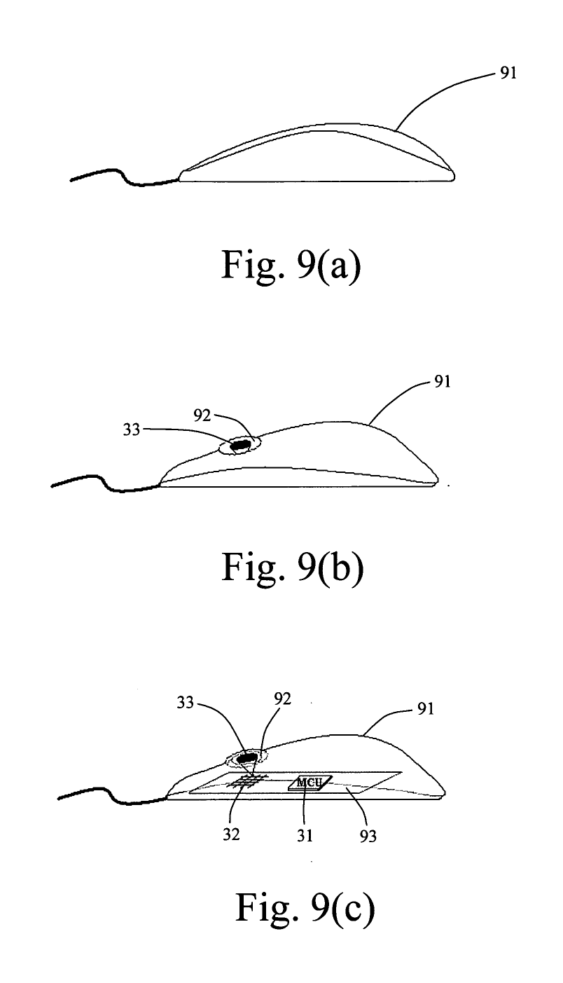

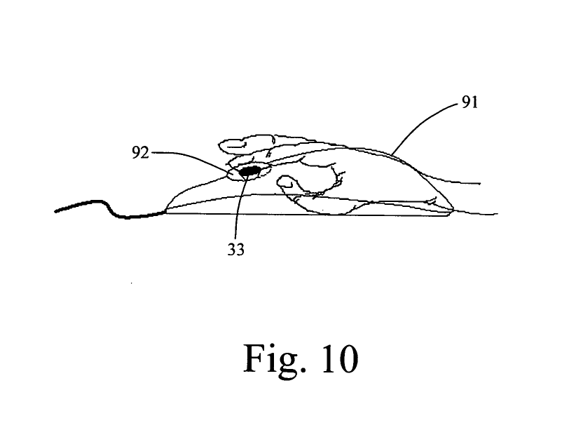

Please refer to FIGS. 9(a)˜9(c), which respectively show a side view, a top view and a cross-sectional view for the controlling device according to a preferred embodiment of the present invention. As shown in FIGS. 9(a)˜9(c), the exterior of the controlling device includes a housing 91 and an operating portion 92 disposed thereon. The interior of the controlling device includes the microprocessor 31 and the capacitor array 32. Preferably, the microprocessor 31 and the capacitor array 32 are disposed on common printed circuit board. The operating portion 92 is an elastic rubber piece connected to the charge-absorbing device 33 for the user to easily operate therethrough with his fingers so as to control the movement of the cursor, as shown in FIG. 10.

In conclusion, the present invention improves the drawbacks of the conventional semi-optical and optical mice, and further achieves the following advantages.

1. The production cost is low due to the omission of photo components (the light-emitting diode and the photo-transistor), the trackball, two keys, two shafts (photoreceptors) and so on.

2. The design is simple since the charge-absorbing device and the microprocessor can be disposed on a common IC. This enables the controlling device to be lighter and thinner, and thus the controlling device is able to be combined with the keyboard or the notebook computer.

3. The operating current is low because no light-emitting components are necessary for the cursor detection. This reduces the operating current significantly.

4. There is no need to clean the controlling device as the sense circuit is disposed inside the controlling device. This keeps the sense circuit from dust.

5. The resolution can be adjusted by the microprocessor according to actual needs.

6. The controlling device of the present invention can also be applied to the function keys of a cellphone, all kinds of toys and other consumer products.

Accordingly, the present invention can effectively solve the problems and drawbacks in the prior art, and thus it fits the demand of the industry and is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A controlling device, comprising:
a capacitor array comprising a plurality of equivalent capacitors;
a microprocessor electrically connected to said capacitor array for sending a pulse train to said capacitor array in x-direction and receiving a potential of each said equivalent capacitor in y-direction so as to determine a movement of a cursor; and
a charge-absorbing device disposed above said capacitor array, wherein when said charge-absorbing device is moved correspondingly to a position of a specific equivalent capacitor in said capacitor array, a storage charge of said specific equivalent capacitor is absorbed so that said potential thereof is lowered, thereby said movement of said cursor being determined by said microprocessor.

2. The controlling device as claimed in claim 1, wherein said capacitor array is in a shape of one selected from a group consisting of a cross, a snake, a comb, a circle and a spiral.

3. The controlling device as claimed in claim 1, wherein said charge-absorbing device is one of a rod and a cone bodies.

4. The controlling device as claimed in claim 1, wherein when said charge-absorbing device is connected to said specific equivalent capacitor, said potential thereof is even lowered, thereby a function being performed as a mouse-click.

5. The controlling device as claimed in claim 1, wherein when said charge-absorbing device is successively connected to said specific equivalent capacitor and then moved away, a function as a scroll wheel is performed.

6. The controlling device as claimed in claim 1, wherein said charge-absorbing device is operated by a user's fingers.

7. The controlling device as claimed in claim 6, wherein said charge-absorbing device is made of an electrically conductive material so that said storage charge of said specific equivalent capacitor is absorbed by said user's fingers via said charge-absorbing device.

8. The controlling device as claimed in claim 1, wherein said charge-absorbing device has a grounded metal bar disposed at a front end thereof for absorbing said storage charge of said specific equivalent capacitor.

9. The controlling device as claimed in claim 1, further comprising a housing and an operating portion.

10. The controlling device as claimed in claim 9, wherein said operating portion is an elastic rubber piece.

11. The controlling device as claimed in claim 10, wherein said elastic rubber piece is disposed on said housing and connected to said charge-absorbing device for said user to easily operate therethrough with his fingers so as to control said movement of said cursor.

12. The controlling device as claimed in claim 1, wherein said capacitor array and said microprocessor are disposed on common printed circuit board.

13. A method for operating a controlling device, wherein said controlling device comprises a capacitor array having a plurality of equivalent capacitors, a microprocessor for sending a pulse train to and receiving a potential of each said equivalent capacitor from said capacitor array, and a charge-absorbing device disposed above said capacitor array, comprising steps of:
determining a movement of a cursor by said microprocessor when said charge-absorbing device is moved correspondingly to a position of a specific equivalent capacitor in said capacitor array and thus a storage charge of said specific equivalent capacitor is absorbed and said potential thereof is lowered; and
determining a selection as a mouse-click by said microprocessor when said charge-absorbing device is connected to said specific equivalent capacitor and thus said potential thereof is even lowered.

14. The method as claimed in claim 13, wherein said pulse train is sent to said capacitor array in x-direction.

15. The method as claimed in claim 13, wherein said potential of each said equivalent capacitor is received from said capacitor array in y-direction.

16. The method as claimed in claim 13, further comprising a step of performing a function as a scroll wheel when said charge-absorbing device is successively connected to said specific equivalent capacitor and then moved away.

17. A method for operating a controlling device, wherein said controlling device comprises a capacitor array having a plurality of equivalent capacitors, a microprocessor for sending a pulse train to and receiving a potential of each said equivalent capacitor from said capacitor array, and a charge-absorbing device disposed above said capacitor array, comprising steps of:
determining a movement of a cursor by said microprocessor when said charge-absorbing device is moved correspondingly to a position of a specific equivalent capacitor in said capacitor array and thus a storage charge of said specific equivalent capacitor is absorbed and said potential thereof is lowered; and
performing a function as a scroll wheel when said charge-absorbing device is successively connected to said specific equivalent capacitor and then moved away.
